(19) United States
(12) Patent Application Publication
(10) Pub. No.: US 2017/0053216 A1
(43) Pub. Date: Feb. 23, 2017

(54) GUARANTEED TRAVEL OFFER PROCESS OVER A COMMUNICATIONS NETWORK

(71) Applicant: Farelogix Inc., Miami, FL (US)

(72) Inventors: Tim Reiz, Miami, FL (US); Vitali Ruppel, Miami, FL (US)

(21) Appl. No.: 14/831,036

(22) Filed: Aug. 20, 2015

(51) Int. Cl. G06Q 10/02; G06Q 30/06; G06Q 50/14

(52) U.S. Cl. CPC G06Q 10/02; G06Q 50/14; G06Q 30/0625

(57) ABSTRACT

A method for providing a travel reservation process to a consumer over a communications network is disclosed. The method includes receiving from a consumer first fare search parameters, performing a search for fare records in the attached database that match the first fare search parameters, evaluating rules from the first matching fare records against attributes from the consumer profile, displaying for the consumer the fare price of the first matching fare records, receiving from the consumer at a later time second fare search parameters substantially identical to the first fare search parameters, performing a search and, for each second matching fare record, if a seat is currently available, if the fare price of the second matching fare record is greater than the fare price of the first matching fare record, and if a time-period has not passed, then displaying the fare price of the first matching fare record.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The disclosed embodiments relate to the field of electronic commerce and, more specifically, the disclosed embodiments relate to the field of providing travel offers over communications networks.

### BACKGROUND

With the emergence of small and mobile computing devices, and the wide availability of high speed network connections, increased opportunities to provide value-added services and offers to customers, as well as additional customer service options, have arisen. One arena where these opportunities have been embraced is the commercial travel industry. Financial troubles and a desire to provide the most economical prices for their customers have led the commercial travel industry (namely, the commercial airline industry) to seek additional ways of attracting customers, increasing consumer satisfaction and generating revenue. One area where the commercial travel industry has yet to make significant improvements in customer satisfaction, however, is in the area of online travel reservations.

Conventional online travel reservation systems allow customers to reserve or purchase fares or seats on commercial transportation via the Web. One of the well-known problems with conventional online travel reservation systems is the dynamic nature of availability and fares. At any given moment, there may be hundreds or thousands of customers logged into an online travel reservation system, and many of those consumers succeed in making reservations or purchasing fares via the system. But because fare offers and seats may be purchased or reserved so quickly by online customers, this leads to a common complaint whereby a customer searching for seats or fares is presented with a fare offer or seat, only to find that at a later time (sometimes within a few minutes) the fare offer or seat is no longer available. This can be annoying and confusing to customers. With the commercial travel industry (especially the commercial airline industry) currently seeking to establish closer relationships with their customers and drive greater loyalty between consumers and brands, greater and more extensive customer satisfaction is sought during the point of sale process, especially during a customer's online travel reservation experience.

Therefore, a need exists to overcome the problems with the prior art, and more specifically, there is a need for a more extensive and improved system and method for providing an online travel reservation experience over a communications network.

### BRIEF SUMMARY

The disclosed embodiments present a method for providing a travel reservation process to a consumer over a communications network. The method includes storing a consumer record, including a consumer profile, in an attached database, storing a plurality of fare records in the attached database, wherein a fare record includes at least a unique identifier, an origin, a destination and one or more rules, wherein each rule defines a fare price or identifies other rules to execute, if predefined conditions are met, receiving from a consumer, over the communications network, first fare search parameters, performing a search for fare records in the attached database that match the first fare search parameters, thereby producing one or more first matching fare records, executing one or more rules from the first matching fare records, wherein said rules are evaluated against attributes from the consumer profile of the consumer record corresponding to the consumer, thereby producing a separate fare price corresponding to each of the first matching fare records, displaying for the consumer, over the communications network, the fare price corresponding to each of the first matching fare records, storing, in the attached database, the following data for each of the first matching fare records: the unique identifier, the fare price, and a time period definition, receiving from the consumer at a later time, over the communications network, second fare search parameters substantially identical to the first fare search parameters, performing a search for fare records in the attached database that match the second fare search parameters, thereby producing one or more second matching fare records, executing one or more rules from the second matching fare records, thereby producing a separate fare price corresponding to each of the second matching fare records, and, for each second matching fare record with a unique identifier equal to a unique identifier of a first matching fare record, if a seat corresponding to said second matching fare record is currently available, if the fare price corresponding to said second matching fare record is greater than the fare price corresponding to said first matching fare record, and if a time-period defined by the time period definition associated with said first matching record has not passed, then displaying for the consumer, over the communications network, the fare price corresponding to said first matching fare record.

Additional aspects of the disclosed embodiments will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating the network architecture of a system for providing a travel reservation process to a consumer over a communications network, in accordance with one embodiment.

FIG. 2 is a block diagram illustrating the data flow of the online travel reservation process provided to a consumer over a communications network, in accordance with one embodiment.

FIG. 3A is a flow chart depicting the general control flow of the process for providing a travel reservation process to a consumer over a communications network, according to one embodiment.

FIG. 3B is a flow chart depicting the control flow of the specific process for determining whether to offer a previous displayed price to a consumer when providing a travel reservation process to a consumer over a communications network, according to one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The disclosed embodiments improve upon the problems with the prior art by providing a system that allows consumers to book travel fares that were previously displayed to the consumer in a previous search session. The disclosed embodiments leverage existing online travel reservations systems to address the common complaint whereby a customer searching for seats or fares is presented with a fare offer or seat, only to find that at a later time (sometimes within a few minutes) the fare offer or seat is no longer available. The disclosed embodiments allow said consumers to enjoy the same fare he or she was shown when previously searching for travel fares by guaranteeing said fare for a certain period of time. Consequently, the disclosed embodiments result in greater and more extensive customer satisfaction during the point of sale process, especially during a customer's online travel reservation experience. An additional benefit of the disclosed embodiments is the potential to establish closer relationships with consumers and drive greater loyalty between airline brands and the consumers they serve.

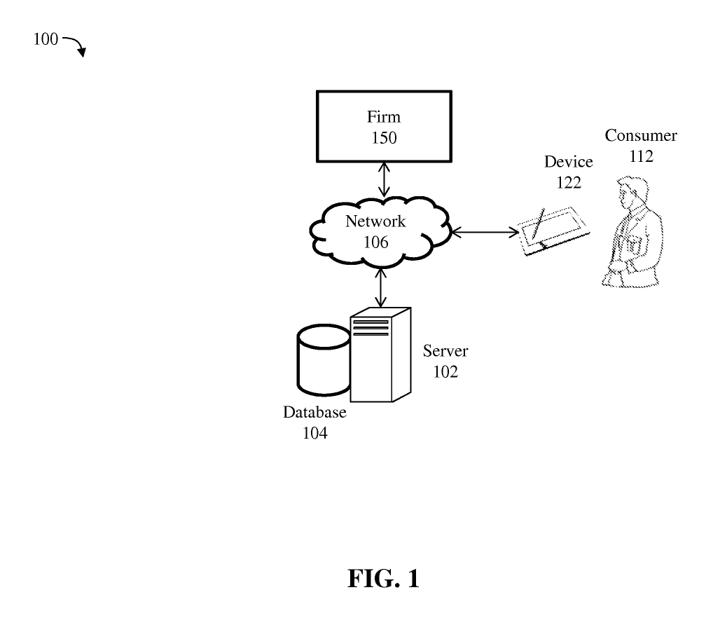

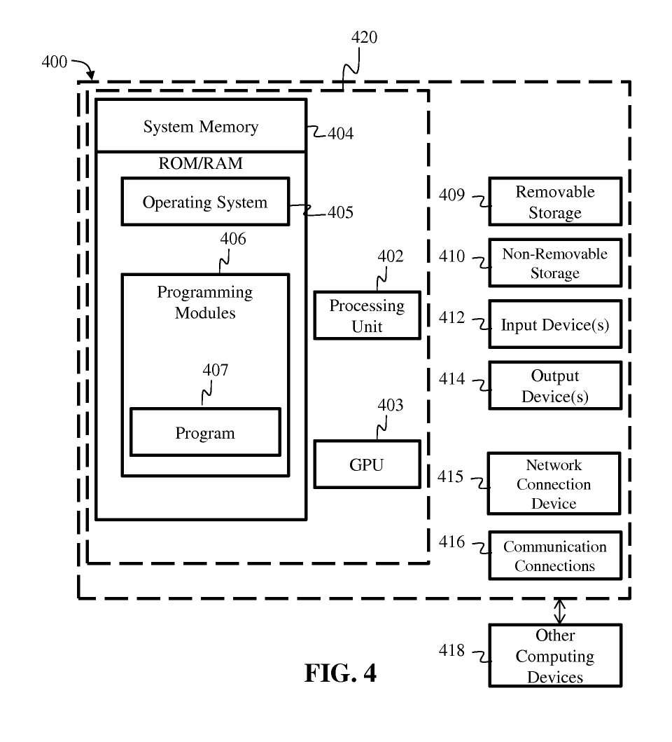

Referring now to the drawing figures in which like reference designators refer to like elements, there is shown in FIG. 1 an illustration of a block diagram showing the network architecture of a system 100 and method for providing a travel reservation process to a consumer over a communications network in accordance with one embodiment. FIG. 1 shows consumer 112 accesses the network 106 via his computing device 122, which may be a mobile computing device, smart phone, mobile phone, handheld computer, laptop, desktop computer, a game console, server, workstation, computer terminal, workstation, or the like. FIG. 1 further shows various components coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Connected to network 106 is server 102, which substantially encompasses the process of providing a travel reservation system to a consumer 112 over communications network 106, as described in greater detail below. Also connected to network 106 is firm 150, which may be a corporation, company, business association or firm that acts as a consumer of server 102's services, such as an airline, a travel services provider, a ticketing provider, a travel agency, a transportation provider, a travel bookings provider, or the like. Server 102 and firm 150 may each include a software engine that delivers applications, data, program code and other information to networked computing devices, such as device 122. Examples of server 102, device 122 and firm 150 are described in greater detail below with reference to FIG. 4. Note that is in this application, the term “consumer” refers to any entity that consumes server 102's travel reservation system services, which may include an individual 112, as shown in FIG. 1, or a corporation, company, business association or firm 150.

FIG. 1 further shows a database or repository 104, which may be a relational database comprising a Structured Query Language (SQL) database stored in a SQL server. The repository 104 serves data from a database, which is a repository for data used by server 102 and device 122 during the course of operation of the disclosed embodiments. Database 104 may be distributed over one or more nodes or locations that are connected via network 106.

The database 104 may include consumer records, which are records that contain the details of a consumer 112. A consumer record 260 may include: a unique consumer identifier, contact/identifying information for the consumer or passenger (name, address, telephone number(s), email address, etc.), additional passenger contact details, passenger age details, passenger frequent flyer data, special service request codes (special meals, etc.), optional services instruction, other service information, vendor remarks, the passenger's gender, passenger passport details, date and place of the passenger's birth, redress number, all available payment/billing information and one or more references to a flight record, such as a unique flight record identifier.

A consumer record may also include a consumer profile which may include a passenger's status (such as elite status, gold status, silver status, local customer status, etc.), which refers to a passenger's position or standing with the airline. Passenger status may also include whether the passenger has paid for an annual subscription to an awards program or whether the passenger is a member of a particular loyalty program. Passenger status may include whether the passenger has a particular status with another airline or with a consortium of airlines or travel providers. Certain benefits, such as free upgrades and free airport lounge stays, are often provided to passengers with a high status, for example. A consumer record may also include the passenger's history with the airline, which may refer to how many years the passenger has flown with the airline, the number of flights the passenger has taken with the airline, the monetary amount the passenger has spent with the airline, the passenger's purchase history, etc. Airlines often provide incentives and benefits to passengers with a long history with the airline, for example.

A consumer record may further include passenger name records, which are records in the database of a computer reservation system that contains the itinerary for a passenger, or a group of passengers travelling together. A passenger name record may include: contact/identifying information for the passenger, contact/identifying information for the travel agent or airline ticket office that generated the ticket (if any), the passenger's seat number, ticketing details such as a ticket number of a ticketing time limit, an itinerary for at least one travel segment, the name of the person providing the information or making the booking, a timestamp, the booking agency's pseudo-city code, a unique all alpha or alpha-numeric record locator, fare details and any restrictions that may apply to the ticket, and the like.

The database 104 may include fare records, which are records in the database of the computer reservation system that contains the details of a fare. Fare records may be associated with a consumer record and or a flight record. A fare record may include: the departure and arrival cities, airports or pseudo-city codes of the fare, the airline providing the fare, a timestamp, the prices associated with the fare, dates and times associated with the fare, fare details and any restrictions that may apply to the ticket, optional services instruction, other service information, vendor remarks, passenger name records or references/pointers to same, etc. The database 104 may also include fare rule records, which are rules that describe how fares are applied and may be changed. Fare rule records may also be associated with a consumer record and or a flight record. A fare rule record may include: blackout dates, memberships in organizations, identities of credit card issuers, additional services that may apply, upgrades that may apply, and any of the data that may be included in a fare record. Fare rule records may also include travel days, sales dates, flight restrictions, mileage restrictions, journey time, applicable regions, etc. In one embodiment, one or more portions of consumer records, fare records and fare rule records may be combined into one or more records.

A rule may be expressed as an if-then statement that defines a condition precedent and a command, a statement, or other rule that is executed if the condition is precedent. The condition may be one or more attributes or facts (such as the current time of year, the passenger status, etc.) that evaluated against another set of attributes of acts (such as the data in a consumer record or a consumer profile).

It should be noted that although FIG. 1 shows only server 102, one database 104, one firm 150, one consumer 112, and one device 122, the disclosed embodiments support any number of servers, databases, firms, consumers, and devices connected via network 106. Also note that although one server 102 is shown as a single and independent entity, in one embodiment, the functions of the server 102 may be integrated with another entity, such as firm 150 or device 122. Further, server 102 and its functionality, according to a preferred embodiment, can be realized in a centralized fashion in one computer system or in a distributed fashion wherein different elements are spread across several interconnected computer systems. Likewise, firm 150 and its functionality, can be realized in a centralized fashion in one computer system or in a distributed fashion wherein different elements are spread across several interconnected computer systems.

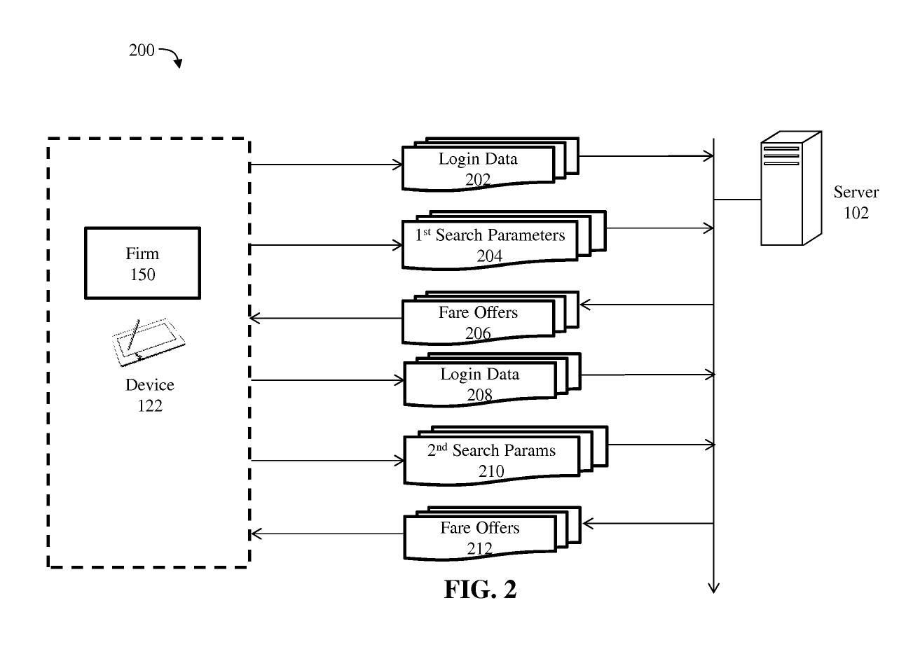

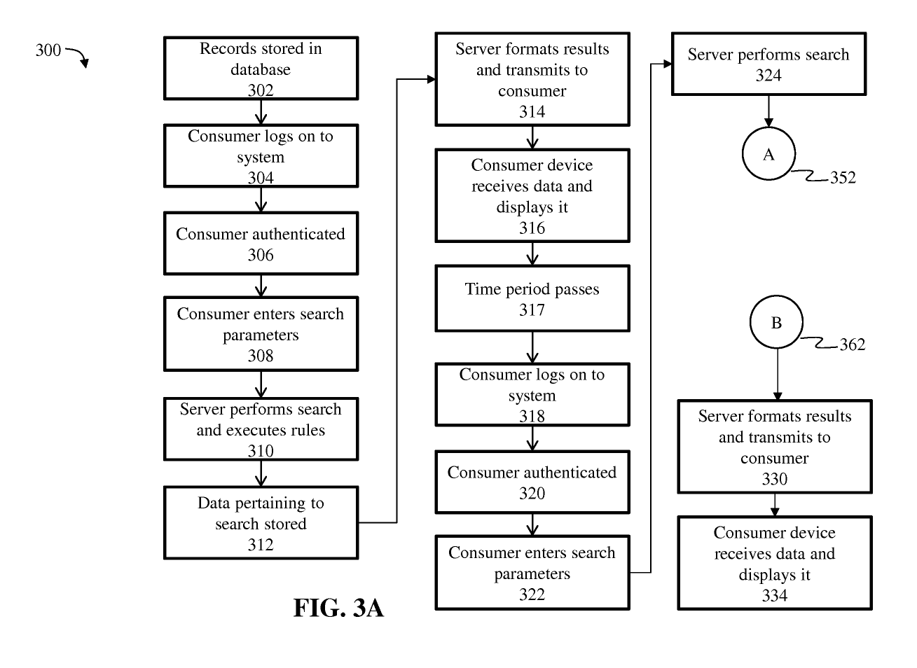

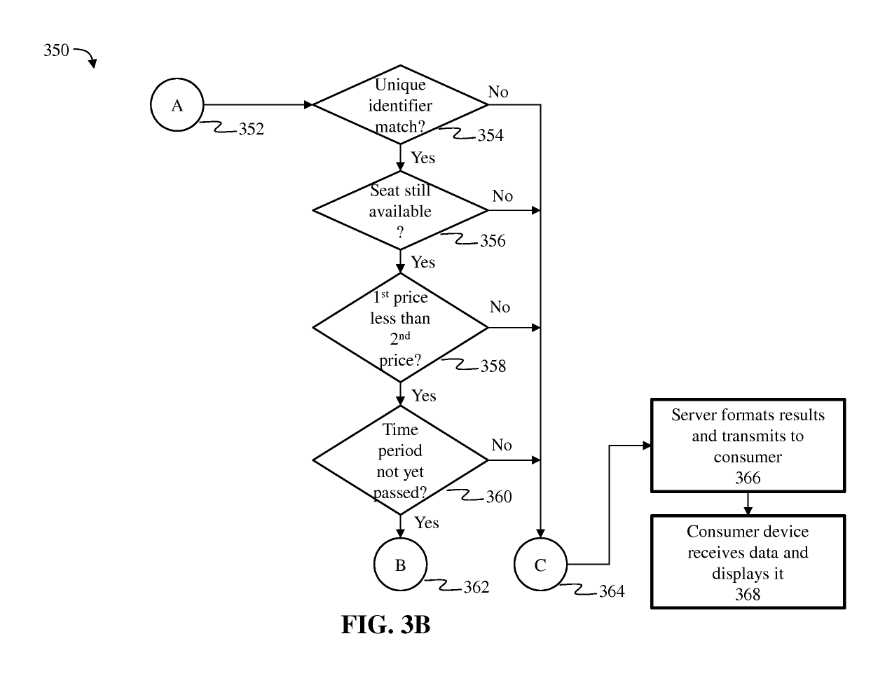

The process of providing a travel reservation process to a consumer over a communications network 106 will now be described with reference to FIGS. 2 through 3B below. FIGS. 2 through 3B depict, among other things, the data flow and control flow in the process for providing a travel reservation system to a consumer 112 over a communications network 106, according to one embodiment. The process of the disclosed embodiments begins with step 302 (see flowchart 300), wherein the server 102 stores all consumer records, fare records and fare rule records in the database 104. Subsequently, the server 102 performs any necessary processing of the data in the database 104, such as indexing, compressing, organizing, etc. In one example, when recording a record, the server 102 includes direct references and/or linked lists among records, thereby avoiding map lookup at runtime. In another example, when recording a record, the server 102 transforms records into compressed structures.

In step 304, the consumer 112 uses his device 122 to log on to the server 102 via network 106. The consumer 112 may log on to the server 102 by entering login data 202 (such as any of the data in a consumer record, or consumer profile) into a graphical user interface (GUI) in his device 122. In step 304, the consumer 112 may also provide to server 102 certain data pertaining to the consumer, such as any of the data stored in a consumer record or fare record, such as a name, destination city, departure city, etc.

In step 306, the server 102 authenticates the consumer 112 by comparing the login data 202 to the login data that is present in the consumer record in the database 104 that corresponds to the consumer 112. This step entails the server 102 using the login data 202 to determine which consumer record in database 104 corresponds to the login data 202 and then accessing said consumer record to perform the comparison above.

In step 308, the consumer 112 enters fare search parameters 204 that are read by server 102. The fare search parameters may include a departure city, airport or location, a destination city, airport or location, departure and return dates, etc. In step 310, the server 102 performs a search for fare records in the attached database 104 that match the fare search parameters, thereby producing one or more first matching fare records. Also in step 310, the server 102 executes one or more rules from the first matching fare records, wherein said rules are evaluated against attributes from the consumer profile of the consumer record corresponding to the consumer 112, thereby producing a separate fare price corresponding to each of the first matching fare records.

In step 312, the server 102 stores, in the attached database 104, the following data for each of the first matching fare records: the unique identifier, the fare price, and a time period definition, which defines a time period during which said fare prices and/or fare offers 206 are valid. In one embodiment, the time period is dynamic and is adjusted based on the rules from the first or second matching fare records, which are executed. In step 314 the server 102 may also store a time stamp that marks the time at which the search for the first matching fare records were found, as well as a unique identifier for the consumer 112 or simply a reference to the corresponding consumer record. The data stored in step 314 may be stored in the corresponding consumer record. In one alternative embodiment, any of the data stored in step 314 may be stored by a client application executing on the device 122 of consumer 112.

In step 314, the server 102 formats the fare prices and/or fare offers 206 from the first matching fare records for display by the consumer 112 on device 122, and transmits via network 106 said fare prices and/or fare offers 206 to the device 122. The formatting step may include, for example, generating HTML that is customized to the device 122 of consumer 112. For example, the server 102 may employ responsive web design, which is a web design methodology aimed at crafting web sites and data to provide an optimal viewing experience—easy reading and navigation with a minimum of resizing, panning, and scrolling—across a wide range of devices.

In step 316, the device 122 receives the fare prices and/or fare offers 206 and displays it for the consumer 112. The consumer 112, however, does not act on the fare prices and/or fare offers 206 at the current time. In step 317, a time period passes and the consumer 112 may log out of the system 100. Server 102 marks the passage of time from the moment the fare offers 206 are transmitted to the consumer.

In step 318 (like step 304), the consumer 112 uses his device 122 to log on to the server 102 via network 106. The consumer 112 may log on to the server 102 by entering login data 208 into a GUI in his device 122. In step 320 (like step 306), the server 102 authenticates the consumer 112 by comparing the login data 208 to the login data that is present in the consumer record in the database 104 that corresponds to the consumer 112. In step 322 (like step 308), the consumer 112 enters fare search parameters 210 that are read by server 102. The fare search parameters may be similar or identical to those entered in step 308. In step 324 (like step 310), the server 102 performs a search for fare records in the attached database 104 that match the fare search parameters, thereby producing one or more second matching fare records. Also in step 322, the server 102 executes one or more rules from the second matching fare records, wherein said rules are evaluated against attributes from the consumer profile of the consumer record, thereby producing a separate fare price corresponding to each of the second matching fare records.

At this juncture, control flows to step 352, which immediately flows to step 354 in FIG. 3B. The server 102 may then execute the steps 354 through 360 with respect to the first matching fare records (and the corresponding fare prices) and the second matching fare records (and the corresponding fare prices).

In step 330, the server 102 formats the fare prices and/or fare offers 212 from the second matching fare records (that were flagged or marked in steps 354-360) for display by the consumer 112 on device 122, and transmits via network 106 said fare prices and/or fare offers 212 to the device 122. In step 334, the device 122 receives the fare prices and/or fare offers 212 and displays it for the consumer 112. Thus, the consumer is able to view the same fares he viewed in step 316 at the same fare prices, thereby guaranteeing said fare prices for a predefined period of time. The consumer 112 may then act on the fare prices and/or fare offers 212 at the current time by purchasing said fare offers via a GUI on his device 122.

Following are the stages or steps performed with respect to FIG. 3B, specifically pertaining to each of the second matching fare records (and the corresponding fare prices) in comparison to the first matching fare records (and the corresponding fare prices). That is, each of the steps 354 through 360 are executed individually for each of the second matching fare records (and the corresponding fare prices).

In step 354, the server 102 determines whether the unique identifier for a fare record or fare offer from the second matching records is identical to the unique identifier for a fare record or fare offer from the first matching records. If the identifiers are identical, the control flows to step 356. Otherwise, control flows to step 364. In step 356, the server 102 determines whether a seat for the fare record or fare offer (from the second matching records) is still available. Server 102 may accomplish this task by transmitting a query to another travel reservation system, such as a third party travel reservation system, and receiving a response from said system. If the seat for the fare record or fare offer is still available, the control flows to step 358. Otherwise, control flows to step 364. In step 358, the server 102 determines whether the fare price for the corresponding fare record or fare offer from the first matching records is less than the fare price for the fare record or fare offer from the second matching records. If the fare price is less, the control flows to step 360. Otherwise, control flows to step 364. In step 364, the server 102 determines whether the time period for the fare price for the fare record or fare offer from the first matching records has passed. Server 102 may accomplish this task by comparing the time that the fare price for the fare record or fare offer from the first matching records was displayed (in step 316) against the current time, to determine whether the defined time period has passed. If the time period has not yet passed, then said fare price for the fare record or fare offer from the second matching records is flagged or marked, and the control flows to step 362. Otherwise, control flows to step 364, which immediately flows to step 366.

In step 366, the server 102 formats the fare prices and/or fare offers 212 from the second matching fare records for display by the consumer 112 on device 122, and transmits via network 106 said fare prices and/or fare offers 212 to the device 122. In step 368, the device 122 receives the fare prices and/or fare offers 212 and displays it for the consumer 112. The consumer 112 may then act on the fare prices and/or fare offers 212 at the current time by purchasing said fare offers via a GUI on his device 122.

In one embodiment, database 104 holds at least 1 million fare records. This number of records is significant in the industry because it represents a minimum number of fare records that are present in a typical medium to large sized airline or other travel provider, and it represents a minimum number of records that must be targeted when performing a travel offer search in order to make the costs of said system feasible. I.e., said number of fare records are necessary in order to provide an acceptable return on investment on the claimed system as described herein. Thus, in this embodiment, in step 302 at least 1 million fare records are stored, in step 310 at least 1 million fare records are searched, and in step 324 at least 1 million fare records are searched.

FIG. 4 is a block diagram of a system including an example computing device 400 and other computing devices. Consistent with the embodiments described herein, the aforementioned actions performed by servers 102 and 150, as well as device 122, may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3B above.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, the disclosed embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

Device 415 may be a network connection device or network interface device (also known as a network interface card, network adapter, LAN adapter, and by similar terms), which is a computer hardware component that connects a computer to a computer network. The network interface device implements the electronic circuitry required to communicate using a specific physical layer and data link layer standard such as Ethernet, Wi-Fi or Token Ring. This provides a base for a full network protocol stack, allowing communication among small groups of computers on the same LAN and large-scale network communications through routable protocols, such as IP.

As stated above, a number of program modules and data files may be stored in system memory 404, including operating system 405. While executing on processing unit 402, programming modules 406 may perform processes including, for example, one or more of the methods shown in FIGS. 2-3B above. Computing device 402 may also include a graphics processing unit 403, which supplements the processing capabilities of processor 402 and which may execute programming modules 406, including all or a portion of those processes and methods shown in FIGS. 2-3B above The aforementioned processes are examples, and processing units 402, 403 may perform other processes. Other programming modules that may be used in accordance with the disclosed embodiments may include electronic mail and contacts applications, word processing applications, spreadsheet applications, database applications, slide presentation applications, drawing or computer-aided application programs, etc.

Generally, consistent with the disclosed embodiments, program modules may include routines, programs, components, data structures, and other types of structures that may perform particular tasks or that may implement particular abstract data types. Moreover, the disclosed embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, the disclosed embodiments may be practiced in an electrical circuit comprising discrete electronic elements, packaged or integrated electronic chips containing logic gates, a circuit utilizing a microprocessor, or on a single chip (such as a System on Chip) containing electronic elements or microprocessors. The disclosed embodiments may also be practiced using other technologies capable of performing logical operations such as, for example, AND, OR, and NOT, including but not limited to mechanical, optical, fluidic, and quantum technologies. In addition, the disclosed embodiments may be practiced within a general purpose computer or in any other circuits or systems.

The disclosed embodiments, for example, are described above with reference to block diagrams and/or operational illustrations of methods, systems, and computer program products according to the disclosed embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain disclosed embodiments have been described, other embodiments may exist. Furthermore, although the disclosed embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A server for providing a travel reservation process to a consumer over a communications network, comprising:
a database for storing a consumer record, including a consumer profile, a unique identifier for a consumer, and login data, in an attached database; and for storing a plurality of fare records, wherein a fare record includes at least a unique identifier, an origin, a destination and one or more rules, wherein each rule defines a fare price or identifies other rules to execute, if predefined conditions are met;
a memory;
a network interface device communicatively coupled with the communications network; and
a processor coupled with the database, the memory and the network interface device, the processor configured for:
receiving from a consumer, over the communications network, login data and first fare search parameters;
authenticating said consumer by comparing the login data received from the consumer against the login data stored in a corresponding consumer record in the database;
performing a search for fare records in the attached database that match the first fare search parameters, thereby producing one or more first matching fare records;
executing one or more rules from the first matching fare records, wherein said rules are evaluated against attributes from the consumer profile of the consumer record corresponding to the consumer, thereby producing a separate fare price corresponding to each of the first matching fare records;
displaying for the consumer, over the communications network, the fare price corresponding to each of the first matching fare records;
storing, in the attached database, the following data for each of the first matching fare records: a unique identifier for the consumer, the unique identifier for the fare record, the fare price, and a time period definition;
receiving from the consumer at a later time, over the communications network, login data and second fare search parameters substantially identical to the first fare search parameters;
authenticating said consumer by comparing the login data received from the consumer against the login data stored in the corresponding consumer record in the database;
performing a search for fare records in the attached database that match the second fare search parameters, thereby producing one or more second matching fare records;
executing one or more rules from the second matching fare records, thereby producing a separate fare price corresponding to each of the second matching fare records;
determining that, for each of the second matching fare records, the unique identifier for each fare record has previously been stored with the unique identifier for the consumer, in the attached database;
and
for each second matching fare record with a unique identifier for the fare record equal to a unique identifier of a first matching fare record, if a seat corresponding to said second matching fare record is currently available, if the fare price corresponding to said second matching fare record is greater than the fare price corresponding to said first matching fare record, and if a time-period defined by the time period definition associated with said first matching record has not passed, then displaying for the consumer, over the communications network, the fare price corresponding to said first matching fare record.

2. (canceled)

3. (canceled)

4. (canceled)

5. The method of claim 1, wherein each rule comprises an if-portion that defines an attribute that is evaluated against attributes from the consumer profile of the consumer record corresponding to the consumer, and a then-portion that defines a fare price or identifies other rules to execute, if the attributes defined in the if-portion are satisfied by the consumer profile.

6. (canceled)

7. (canceled)

8. (canceled)

9. (canceled)

10. A computer system for providing a travel reservation process to a consumer over a communications network, comprising:
a database for storing a consumer record, including a consumer profile, a unique identifier for a consumer, and login data, and for storing at least one million fare records, wherein a fare record includes at least a unique identifier, an origin, a destination and one or more rules, wherein each rule defines a fare price or identifies other rules to execute, if predefined conditions are met;
a memory;
a network interface device communicatively coupled with the communications network; and
a processor coupled with the database, the memory and the network interface device, the processor configured for:
receiving from a consumer, over the communications network, login data and first fare search parameters;
authenticating said consumer by comparing the login data received from the consumer against the login data stored in a corresponding consumer record in the database;
performing a search for fare records in the attached database that match the first fare search parameters, thereby producing one or more first matching fare records;
executing one or more rules from the first matching fare records, wherein said rules are evaluated against attributes from the consumer profile of the consumer record corresponding to the consumer, thereby producing a separate fare price corresponding to each of the first matching fare records;
displaying for the consumer, over the communications network, the fare price corresponding to each of the first matching fare records;
storing, in the attached database, the following data for each of the first matching fare records: a unique identifier for the consumer, the unique identifier for the fare record, the fare price, and a time period definition;
receiving from the consumer at a later time, over the communications network, login data and second fare search parameters substantially identical to the first fare search parameters;
authenticating said consumer by comparing the login data received from the consumer against the login data stored in the corresponding consumer record in the database;
performing a search for fare records in the attached database that match the second fare search parameters, thereby producing one or more second matching fare records;
executing one or more rules from the second matching fare records, thereby producing a separate fare price corresponding to each of the second matching fare records;
determining that, for each of the second matching fare records, the unique identifier for each fare record has previously been stored with the unique identifier for the consumer, in the attached database;
and
for each second matching fare record with a unique identifier for the fare record equal to a unique identifier of a first matching fare record, if a seat corresponding to said second matching fare record is currently available, if the fare price corresponding to said second matching fare record is greater than the fare price corresponding to said first matching fare record, and if a time-period defined by the time period definition associated with said first matching record has not passed, then displaying for the consumer, over the communications network, the fare price corresponding to said first matching fare record.

11. (canceled)

12. (canceled)

13. (canceled)

14. The computer system of claim 10, wherein each rule comprises an if-portion that defines an attribute that is evaluated against attributes from the consumer profile of the consumer record corresponding to the consumer, and a then-portion that defines a fare price or identifies other rules to execute, if the attributes defined in the if-portion are satisfied by the consumer profile.

15. The computer system of claim 14, wherein the memory further comprises:
a distributed memory.
